(19) United States
(12) Patent Application Publication
(10) Pub. No.: US 2023/0027764 A1
(43) Pub. Date: Jan. 26, 2023

(54) INTEGRATED FUEL CELL CONTROL SYSTEM AND CONTROL METHOD USING THE SAME

(71) Applicants: Hyundai Motor Company, Seoul (KR); Kia Corporation, Seoul (KR)

(72) Inventors: Ji Tae KIM, Seoul (KR); Keun Bong HAM, Yongin-si (KR)

(73) Assignees: Hyundai Motor Company, Seoul (KR); Kia Corporation, Seoul (KR)

(21) Appl. No.: 17/728,420

(22) Filed: Apr. 25, 2022

(30) Foreign Application Priority Data
Jul. 22, 2021 (KR) 10-2021-0096514

(51) Int. Cl. H01M 8/04007; H01M 8/04029; H01M 8/0432; H01M 8/04746

(52) U.S. Cl. CPC H01M 8/04067; H01M 8/04029; H01M 8/04358; H01M 8/04768

(57) ABSTRACT

An integrated fuel cell control system including at least one valve installed to control a fluid in a fuel cell system, at least one drive motor configured to drive the valve, at least one sensor configured to detect the opening degree of the valve, and a fuel cell control unit configured to control the fuel cell system, wherein the fuel cell control unit includes a drive logic unit configured to calculate a motor control amount for controlling the drive motor based on information detected by the sensor and an operator request value and a drive unit configured to operate the drive motor based on the motor control amount determined by the drive logic unit, and an integrated control method including the same.

### CROSS-REFERENCE TO RELATED APPLICATION

This application claims the benefit of Korean Patent Application No. 10-2021-0096514, filed on Jul. 22, 2021, with the Korean Intellectual Property Office, the disclosure of which is herein incorporated by reference in its entirety.

### TECHNICAL FIELD

The present disclosure relates to an integrated fuel cell control system and a control method using the same, and more particularly to an integrated fuel cell control system capable of performing integrated valve control using an actuator of a subordinate system in a fuel cell system, such as a thermal management system or an air supply system, through a fuel cell control unit and a control method using the same.

### BACKGROUND

A fuel cell system includes various kinds of subordinate systems, such as a hydrogen supply system, an air supply system, a thermal management system, a high-voltage battery, a drive motor and a power conversion control unit, a fuel cell control unit, and a fuel cell monitoring control unit.

Each subordinate system has a separator control unit and is configured to directly control a sensor and a valve depending on the state of the fuel cell system. In addition, the fuel cell system includes a fuel cell control unit (FCU) configured to collectively control components thereof, and the valve is controlled though control cooperation with the fuel cell control unit.

Consequently, a part configured to drive an actuator in the valve in order to perform direct control though control cooperation with the fuel cell control unit is included in each subordinate system. For example, the part controls opening of the valve based on sensor information in the system through control cooperation with the fuel cell control unit.

In a conventional fuel cell system, however, a plurality of control circuits is included in each subordinate system, whereby part cost is increased, and circuit complexity is increased by the provision of various control units.

The matters disclosed in this section are merely for enhancement of understanding of the general background of the disclosure and should not be taken as an acknowledgment or any form of suggestion that the matters form the related art already known to a person skilled in the art.

### SUMMARY

The present disclosure has been made in view of the above problems, and it is an object of the present disclosure to provide an integrated fuel cell control system capable of directly performing integrated driving control of an actuator, such as a DC motor, and a valve configured to be driven thereby, among subordinate system parts in a fuel cell system, through a fuel cell control unit and a control method using the same.

It is another object of the present disclosure to provide a control unit having a new structure in which a drive control unit is integrated into a fuel cell control unit in order to control a valve and an actuator configured to drive the valve included in an air supply system or a thermal management system such that the actuator configured to drive the valve included in the air supply system or the thermal management system is directly controlled by the fuel cell control unit.

In accordance with an aspect of the present disclosure, the above and other objects can be accomplished by the provision of an integrated fuel cell control system including at least one valve installed to control a fluid in a fuel cell system, at least one drive motor configured to drive the valve, at least one sensor configured to detect the opening degree of the valve, and a fuel cell control unit configured to control the fuel cell system, wherein the fuel cell control unit includes a drive logic unit configured to calculate a motor control amount for controlling the drive motor based on information detected by the sensor and an operator request value and a drive unit configured to operate the drive motor based on the motor control amount determined by the drive logic unit.

The fuel cell control unit may further include a power unit configured to operate the driving motor in order to open the valve.

The valve is an air pressure adjustment valve configured to control pressure of supplied air or a coolant temperature adjustment valve configured to control coolant temperature, the sensor may check a current opening degree of the valve and may transmit the current opening degree of the valve to the drive logic unit, and the drive logic unit may determine the opening degree of the valve to be changed based on the current opening degree of the valve and the operator request value and may calculate the motor control amount based thereon.

The drive motor may be a direct-current motor, and the motor control amount may be a PWM control drive current value determined based on the opening degree of the valve to be changed and directly applied to the drive motor.

In accordance with another aspect of the present disclosure, there is provided an integrated fuel cell control method including a valve opening control step of controlling, by a fuel cell control unit, opening of a valve according to a predetermined initial condition at the time of start of a fuel cell system, an opening-degree-of-valve checking step of checking, by a sensor, the opening degree of the valve, a step of calculating, by the fuel cell control unit, a motor control amount for controlling a drive motor with respect to the valve based on the opening degree of the valve checked in the opening-degree-of-valve checking step and an operator request value, and a step of operating, by the fuel cell control unit, the drive motor based on the motor control amount.

In the opening-degree-of-valve checking step, the fuel cell control unit may directly receive a signal from the sensor to check the opening degree of the valve.

The valve may be an air pressure adjustment valve configured to control pressure of supplied air or coolant temperature adjustment valve configured to control coolant temperature, and the current opening degree of the air pressure adjustment valve may be checked in the opening-degree-of-valve checking step.

In step of calculating the motor control amount, a drive logic unit of the fuel cell control unit may determines the opening degree of the valve to be changed based on the current opening degree of the valve and the operator request value, and may calculate the motor control amount based on the opening degree of the valve to be changed.

The motor control amount may be a PWM control drive current value to be applied to the drive motor in order to control the valve based on the opening degree of the valve to be changed, and PWM control drive current generated by a drive unit of the fuel cell control unit may be directly applied to the drive motor in order to operate the drive motor such that the opening degree of the valve is changed to the opening degree of the valve to be changed in the step of operating the drive motor.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view schematically showing the construction of a fuel cell system;

FIG. 2 is a view conceptually showing the construction of a control apparatus of the fuel cell system compared to an integrated fuel cell control apparatus according to the present disclosure;

FIG. 3 is a flowchart showing an air pressure adjustment valve control method of the fuel cell system compared to an integrated fuel cell control method according to the present disclosure;

FIG. 4 is a flowchart showing a coolant temperature adjustment valve control method of the fuel cell system compared to the integrated fuel cell control method according to the present disclosure;

FIG. 5 is a view conceptually showing the construction of an integrated fuel cell control apparatus according to an embodiment of the present disclosure;

FIG. 6 is a flowchart showing an air pressure adjustment valve control method of the fuel cell system in the integrated fuel cell control method according to the present disclosure; and

FIG. 7 is a flowchart showing a coolant temperature adjustment valve control method of the fuel cell system in the integrated fuel cell control method according to the present disclosure.

### DETAILED DESCRIPTION OF THE PREFERRED EMBODIMENTS

Hereinafter, an integrated fuel cell control apparatus and method according to various embodiments of the present disclosure will be described in detail with reference to the accompanying drawings.

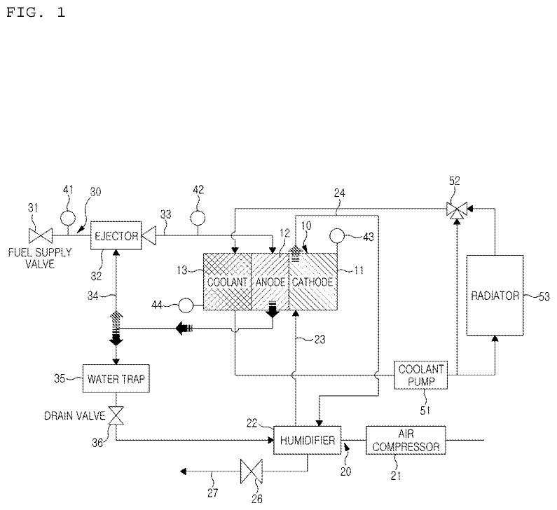

FIG. 1 is a view schematically showing the construction of a fuel cell system including a fuel cell stack and an air supply device, a hydrogen supply device, and a thermal management device connected thereto.

Referring to FIG. 1, the air supply device 20 configured to supply air is connected to a cathode of the fuel cell stack 10, and the hydrogen supply device 30 configured to supply hydrogen is connected to an anode of the fuel cell stack 10.

The air supply device 20 may include an air compressor 21 configured to suction external air and to transmit the external air to a humidifier in a compressed state and the humidifier 22 configured to humidify the compressed air so as to have appropriate humidity. Air that has passed through the humidifier 22 reacts with hydrogen at the anode 12 while passing through the cathode 11 via an air supply line 23. A membrane humidifier configured to perform moisture exchange between moisture in wet gas discharged after fuel cell reaction and air supplied from the outside may be mainly used as the humidifier 22. To this end, air discharged from an outlet of the cathode may be resupplied to the humidifier 22 via an air return line 24. In addition, an air pressure adjustment valve 26 is installed at one side of the humidifier 22, and wet gas that has not participated in humidification is discharged to the outside via an air exhaust line 27 through the air pressure adjustment valve 26. The air pressure adjustment valve 26 may adjust rotational speed of the air compressor 21, and the opening degree of the air pressure adjustment valve 26 may be adjusted to adjust pressing force of air that is supplied to the cathode, simultaneously therewith or independent thereof.

In the hydrogen supply system 30, hydrogen supplied through a fuel supply valve 31 is supplied to the anode 12 via an ejector 32 and a hydrogen supply line 33. Pressure sensors 41 and 42 configured to detect pressure may be installed at front and rear ends of the ejector 32, respectively.

Meanwhile, some of the hydrogen supplied to the anode that has not participated in reaction may recirculate to the front end of the anode via a hydrogen recirculation line 34 so as to be supplied to the anode again. At this time, condensate in the anode is discharged together with some hydrogen that has not participated in reaction. A water trap 35 configured to capture the condensate is installed at an outlet of the anode.

A drain valve 36 may be installed at the lower end of the water trap 35, and the condensate may be discharged to the outside through the drain valve 36. In this case, the condensate discharged through the drain valve 36 may be discharged to the outside via the air exhaust line 27, or may be transmitted to the humidifier 22 of the air supply system so as to be utilized for humidification, as shown in FIG. 1.

In addition, a coolant channel 13 configured to supply coolant is installed in the fuel cell stack, and the thermal management device controls the temperature of the coolant that passes through the coolant channel. The thermal management device includes a coolant pump 51 configured to pump coolant and a radiator 53 configured to adjust the temperature of the coolant through heat exchange. The radiator 53 is installed in a state of diverging from a coolant supply line, and a coolant temperature adjustment valve 52 configured to control the flow rate of the coolant that passes through the radiator 53 is installed on the coolant supply line. The coolant temperature adjustment valve may be implemented by a three-way valve, as shown in FIG. 1. The opening degree of the coolant temperature adjustment valve may be controlled to adjust the temperature of the coolant based on requirements.

Meanwhile, the fuel cell system includes a fuel cell control unit (FCU) configured to collectively control a fuel cell. The fuel cell control unit (FCU) means a superordinate control unit configured to perform coolant temperature control, fuel cell stack control, and module on/off control, and is configured to collectively control various subordinate systems included in the fuel cell system depending on operation conditions.

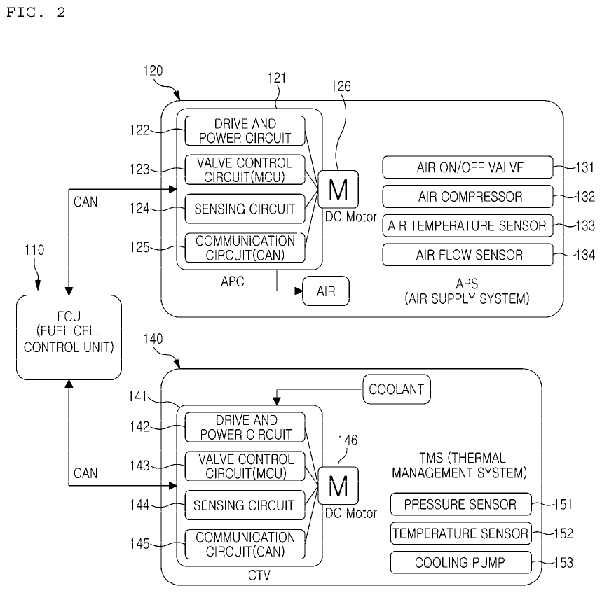

Hereinafter, an integrated fuel cell control apparatus and method applicable to the fuel cell system shown in FIG. 1 will be described in detail with reference to FIGS. 2 to 7.

First, FIGS. 2 to 4 show examples of a fuel cell control apparatus and method compared to an integrated fuel cell control apparatus and method according to the present disclosure.

Particularly, FIGS. 2 to 4 illustrate an example in which valves of an air supply device 120 and a thermal management device 140 are controlled not by a fuel cell control unit 110 but by control units in the respective devices.

Specifically, FIG. 2 shows an example in which an air pressure adjustment valve and a coolant temperature adjustment valve are controlled by the control units mounted in the air supply device and the thermal management device, respectively.

In the fuel cell control apparatus of FIG. 2, the air supply device (APS) and the thermal management device (TMS) include an air pressure adjustment control unit (APC) configured to control air pressure and a valve control unit (CTV) configured to control coolant temperature, and drive motors configured to drive the valves are controlled by the control units in the respective devices.

The air supply device 120 may include an air on/off valve 131, an air compressor 132, an air temperature sensor 133, and an air flow sensor 134. In addition, the air supply device includes an air pressure adjustment valve configured to control air pressure and a drive motor 126 configured to drive the air pressure adjustment valve, and includes an air pressure adjustment control unit 121 configured to control the air pressure adjustment valve and the drive motor. In controlling air pressure, the air pressure adjustment control unit 121 is configured to adjust the opening degree of the valve while communicating with the fuel cell control unit 110, which is a superordinate control unit, through CAN communication.

To this end, the air pressure adjustment control unit 121 includes a drive and power circuit 122 configured to control the drive motor 126, a valve control circuit 123 including a microcomputer, a sensing circuit 124 configured to measure the opening degree of the valve, and a communication circuit 125 configured to perform CAN communication.

In addition, the thermal management device 140 may include a pressure sensor 151, a temperature sensor 152, a cooling pump 153, and a coolant temperature valve control unit 141. In addition, the thermal management device 140 includes a coolant temperature adjustment valve configured to control the amount of a coolant that passes through a radiator, and includes a drive motor 146 configured to adjust the opening degree of the coolant temperature adjustment valve. Particularly, the coolant temperature valve control unit 141 is also configured to adjust the opening degree of the valve while communicating with the fuel cell control unit 110, which is a superordinate control unit, through CAN communication. To this end, in the same manner as the air pressure adjustment control unit 121, the coolant temperature valve control unit 141 includes a drive and power circuit 142 configured to control the drive motor, a valve control circuit 143 including a microcomputer, a sensing circuit 144 configured to measurement the opening degree of the valve, and a communication circuit 145 configured to perform CAN communication.

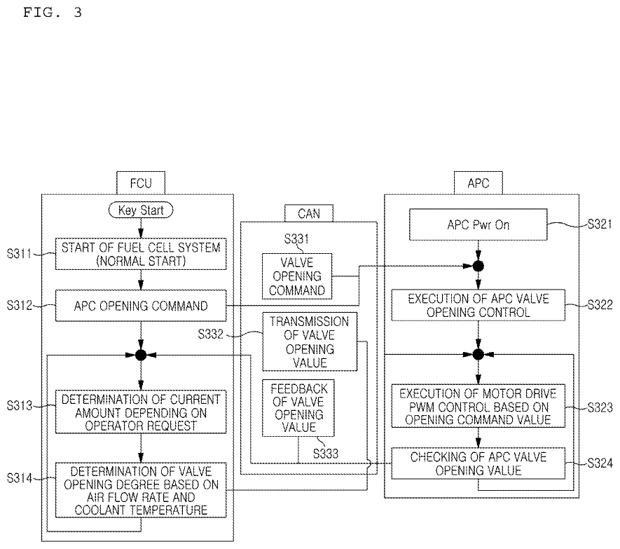

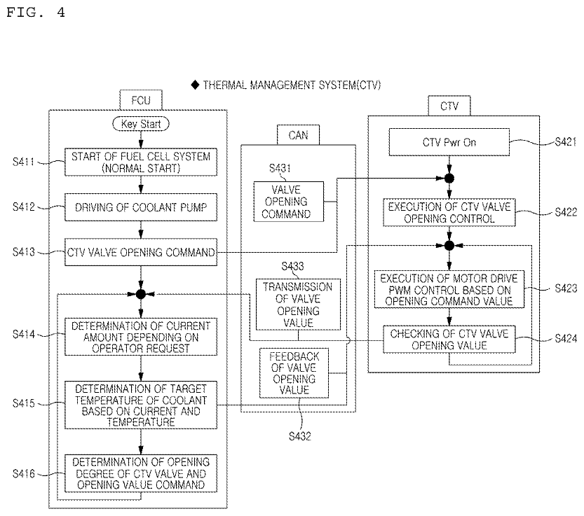

A general valve control method using the fuel cell control apparatus of FIG. 2 is shown in FIGS. 3 and 4,

First, FIG. 3 is a flowchart showing an air pressure adjustment valve control method of the fuel cell system compared to the integrated fuel cell control method according to the present disclosure.

The control method of FIG. 3 is divided into control steps through a fuel cell control unit, which is a superordinate control unit, and control steps through an air pressure adjustment control unit, which is a subordinate control unit, and control commands and variables are transmitted between the superordinate control unit and the subordinate control unit through CAN communication.

As shown in FIG. 3, when the fuel cell system is started (S311), an APC valve opening command is issued (S312), and the valve opening command is transmitted to the air pressure adjustment control unit (S331).

Meanwhile, when the fuel cell system is started, the air pressure adjustment control unit is powered on (S321) and receives the valve opening command to perform APC valve opening control (S322). At this time, the air pressure adjustment control unit performs pulse width modulation (PWM) control for the drive motor based on an opening command value (S323), and checks the opening value of the APC valve through the sensing circuit.

The checked opening value of the APC valve is fed back to the fuel cell control unit through CAN communication (S333), and a new valve opening degree is determined based on the fed-back opening value of the APC valve and an operator request value (S313 and S314). General techniques used in a conventional fuel cell system may be applied to a process of determining the new valve opening degree. For example, a required amount of stack current is determined depending on operator request (S313), and the opening degree of the valve may be determined based on air flow rate and coolant temperature according to this value (S314). The determined opening degree of the valve may be transmitted to the air pressure adjustment control unit through CAN communication again (S332), and a process of adjusting the opening of the APC valve based on a new opening degree of the valve having the operator request reflected therein is identically performed.

FIG. 4 is a flowchart showing a coolant temperature adjustment valve control method of the fuel cell system compared to the integrated fuel cell control method according to the present disclosure, wherein the method of FIG. 4 is substantially identical to the method of FIG. 3 except that the thermal management device is a target.

That is, when the fuel cell system is started (S411), the coolant pump is driven (S412), a CTV valve opening command is issued (S413), and the valve opening command is transmitted to the coolant temperature valve control unit (S431).

Meanwhile, when the fuel cell system is started, the coolant temperature valve control unit is powered on (S421) and receives the valve opening command to perform CTV valve opening control (S422). At this time, the coolant temperature valve control unit performs pulse width modulation (PWM) control for the drive motor based on an opening command value (S423), and checks the opening value of the CTV valve through the sensing circuit.

The checked opening value of the CTV valve is fed back to the fuel cell control unit through CAN communication (S433), and a new valve opening degree is determined based on the fed-back opening value of the CTV valve and an operator request value (S414 to S416). General techniques used in a conventional fuel cell system may be applied to a process of determining the new valve opening degree. For example, a required amount of stack current is determined depending on operator request (S414), and target temperature of the coolant is determined based on this value and temperature (S415). Subsequently, the opening degree of the CTV valve and an opening value command based thereon may be determined based on the determined target temperature of the coolant (S416). The determined opening degree of the valve may be transmitted to the coolant temperature valve control unit through CAN communication again (S432), and a process of adjusting the opening of the CTV valve based on a new opening degree of the valve having the operator request reflected therein is identically performed.

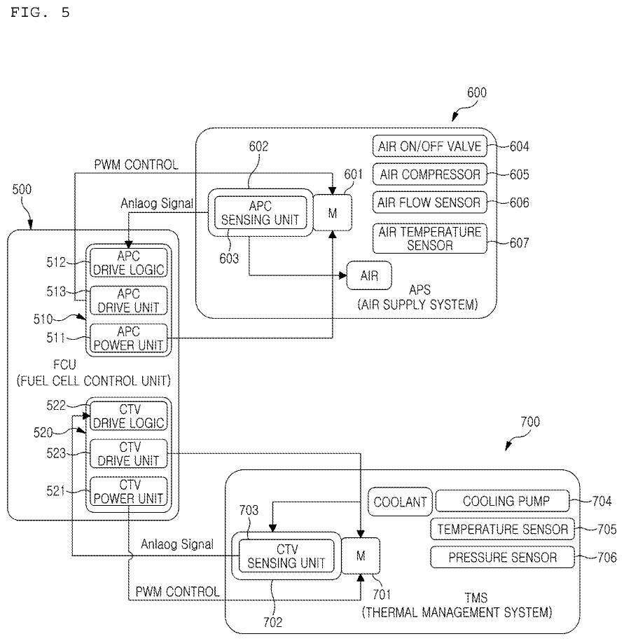

An integrated fuel cell control apparatus and method according to a preferred embodiment of the present disclosure compared to the fuel cell control apparatus and method of FIGS. 2 to 4 are shown in FIGS. 5 to 7.

Particularly, FIG. 5 shows the construction of an integrated fuel cell control apparatus according to an embodiment of the present disclosure.

As shown in FIG. 5, the integrated fuel cell control apparatus according to the embodiment of the present disclosure is characterized in that both opening degrees of a valve of an air supply device 600 and a valve of a thermal management device 700 are directly controlled by a fuel cell control unit 500, which is a superordinate control unit. Consequently, the air supply device 600 is configured such that opening degrees of the valves can be controlled by an APC control zone 510 and a CTV control zone 520, not by a separate subordinate control unit.

The air supply device 600 may include an air on/off valve 604, an air compressor 605, an air flow sensor 606, and an air temperature sensor 607, in the same manner as the conventional device.

However, the air supply device does not include a separate subordinate control device configured to control an air pressure adjustment valve 602 installed to adjust air pressure, and is preferably configured to include only an APC drive motor 601 configured to drive the air pressure adjustment valve 602 and an APC sensing unit 603 including a sensor configured to detect the opening degree of the air pressure adjustment valve 602.

Meanwhile, the fuel cell control unit 500 according to this embodiment, which is a control unit configured to collectively control the fuel cell system, is configured to directly control the opening degree of the air pressure adjustment valve 602. To this end, the fuel cell control unit 500 has an APC control zone 510, and the APC control zone 510 may include an APC power unit 511, an APC drive logic unit 512, and an APC drive unit 513.

In addition, the APC power unit 511 of the fuel cell control unit 500 may be a power circuit for the drive motor. Through the APC power unit 511, the fuel cell control unit 500 may operate the APC drive motor 601 to open the air pressure adjustment valve 602 at the initial stage of start.

The APC drive logic unit 512 may directly receive information related to the opening degree of the valve detected by the sensor of the sensing unit and may create control input based on predetermined control logic in order to drive the motor. Consequently, the APC drive logic unit 512 may be configured to directly calculate a motor control amount for controlling the drive motor based on information detected by the sensor and an operator request value. The motor control amount may be a required opening degree of the valve to be changed, and is preferably a drive current value for PWM control of a DC motor.

In connection therewith, as shown in FIG. 5, the APC drive logic unit 512 may directly receive information about the opening degree of the valve from the APC sensing unit 603, not through CAN communication. For example, the APC sensing unit 603 may be directly connected to the fuel cell control unit 500 via a wire in order to directly transmit an analog signal from the sensor to the fuel cell control unit 500 without the CAN communication circuit.

The APC drive logic unit 512 may be a processor having motor drive control logic, and is preferably implemented by adding the motor drive control logic in the microcomputer of the fuel cell control unit 500.

In addition, the APC drive unit 513 is configured to directly control operation of the drive motor based on the motor control amount determined by the APC drive logic unit 512. Consequently, the APC drive unit 513 may be constituted by a drive circuit configured to directly operate the APC drive motor 601 based on the motor control amount determined by the APC drive logic unit 512. The drive circuit is configured to generate PWM control drive current for operating the drive motor, and the PWM control drive current generated by the drive circuit may be directly applied to the drive motor, which is a DC motor, to perform motor drive control and valve opening control. According to the predetermined embodiment of the present disclosure, therefore, the APC drive logic unit 512 may directly calculate a motor control amount for a necessary opening degree of the valve, and the APC drive unit 513 may directly control motor driving according to PWM control based on the calculated amount of motor control.

Additionally, the fuel cell control unit may determine fault of the air supply device and may perform integrated fault diagnosis and troubleshooting.

Meanwhile, according to another embodiment of the present disclosure, the valve may be a coolant temperature adjustment valve 702 included in the thermal management device 700, and the fuel cell control unit 500 may be configured to directly control motor driving for controlling the opening degree of the coolant temperature adjustment valve 702. This embodiment relates to a control system for the thermal management device 700 shown at the lower end of FIG. 5.

Referring to FIG. 5, the thermal management device 700 may include a cooling pump 704, a temperature sensor 705, and a pressure sensor 706, in the same manner as the conventional device. In addition, the thermal management device 700 may include a coolant temperature adjustment valve 702 configured to control the amount of coolant that passes through a radiator.

In this embodiment, however, the thermal management device does not include a separate subordinate control device configured to control the coolant temperature adjustment valve 702, and is preferably configured to include only a CTV drive motor 701 configured to adjust the opening degree of the coolant temperature adjustment valve 702 and a CTV sensing unit 703 including a sensor configured to detect the opening degree of the coolant temperature adjustment valve 702.

Meanwhile, a device configured to perform integrated control of a valve drive motor of the thermal management device 700 is also configured so as to be basically identical to the case of the embodiment related to the air supply device 600 described above. That is, even in this embodiment, the coolant temperature adjustment valve 702 and the drive motor are directly controlled by the fuel cell control unit 500.

To this end, the fuel cell control unit 500 has a CTV control zone 520, and the CTV control zone 520 may include a CTV power unit 521, a CTV drive logic unit 522, and a CTV drive unit 523.

The CTV drive logic unit 522 may directly receive information related to the opening degree of the valve detected by the sensor of the sensing unit and may create control input based on predetermined control logic in order to drive the motor. Consequently, the CTV drive logic unit 522 may be configured to directly calculate a motor control amount for controlling the CTV drive motor 701 based on information detected by the sensor and an operator request value. The motor control amount may be a required opening degree of the valve to be changed, and is preferably a drive current value for PWM control of a DC motor.

In connection therewith, as shown in FIG. 5, the CTV drive logic unit 522 may directly receive information about the opening degree of the valve from the CTV sensing unit 703, not through CAN communication. For example, the CTV sensing unit 703 may be directly connected to the fuel cell control unit 500 via a wire in order to directly transmit an analog signal from the sensor to the fuel cell control unit 500 without the CAN communication circuit.

The CTV drive logic unit 522 may be a processor having motor drive control logic, and is preferably implemented by adding the motor drive control logic in the microcomputer of the fuel cell control unit 500.

In addition, the CTV drive unit 523 is configured to directly control operation of the drive motor based on the motor control amount determined by the CTV drive logic unit 522. Consequently, the CTV drive unit 523 may be constituted by a drive circuit configured to directly operate the CTV drive motor 701 based on the motor control amount determined by the CTV drive logic unit 522. The drive circuit is configured to generate PWM control drive current for operating the drive motor, and the PWM control drive current generated by the drive circuit may be directly applied to the drive motor, which is a DC motor, to perform motor drive control and valve opening control. According to the predetermined embodiment of the present disclosure, therefore, the CTV drive logic unit 522 may directly calculate a motor control amount for a necessary opening degree of the valve, and the CTV drive unit 523 may directly control motor driving according to PWM control based on the calculated amount of motor control.

In addition, the CTV power unit 521 of the fuel cell control unit 500 may be a power circuit for the CTV drive motor 701 of the coolant temperature adjustment valve 702. Through the CTV power unit 521, the fuel cell control unit 500 may operate the drive motor to open the coolant temperature adjustment valve 702 at the initial stage of start.

Additionally, the fuel cell control unit may determine fault of the thermal management device and may perform integrated fault diagnosis and troubleshooting.

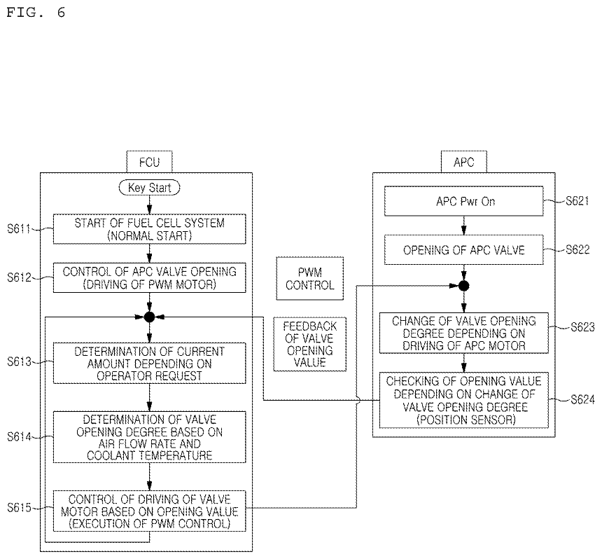

FIG. 6 is a flowchart showing an air pressure adjustment valve control method of the fuel cell system in the integrated fuel cell control method according to the present disclosure.

Referring to FIG. 6, the integrated fuel cell control method according to the embodiment of the present disclosure is characterized in that the APC drive motor and the air pressure adjustment valve (APC valve) are directly controlled by the fuel cell control unit, not through CAN communication.

As shown in FIG. 6, when the fuel cell system is started in a normal start mode (S611), PWM motor drive control for opening the air pressure adjustment valve may be performed based on a predetermined initial opening degree (S612). At this time, in the air supply device, the valve is opened as the drive motor is operated by control input based on the initial opening degree (S622).

In an initial state, in which the opening degree of the valve is not changed, step S623 may be omitted, and an opening value of the valve may be checked by a position sensor in step S624. The checked opening value of the valve may be transmitted to the fuel cell control unit as an analog feedback signal of the position sensor so as to be utilized to determine the opening degree of the valve to be newly changed.

In connection therewith, the fuel cell control unit determines a new valve opening degree based on the fed-back opening value of the APC valve and an operator request value (S613 and S614). General techniques used in a conventional fuel cell system may be applied to a process of determining the new valve opening degree. For example, a required amount of stack current is determined depending on operator request (S613), and the opening degree of the valve may be determined based on air flow rate and coolant temperature according to this value (S614). When the opening degree of the valve to be changed is determined through the above process, a step of controlling driving of the motor of the valve based on the determined opening degree of the valve to be changed is performed (S615). In this step (S615), PWM drive control for the motor may be performed in real time based on a command value of the fuel cell control unit to change the opening degree of the valve (S623).

When motor drive control for satisfying a desired opening degree of the valve is completed, a step of checking the current opening degree of the valve again through the position sensor (S624) may be performed, and a process of adjusting the opening of the APC valve based on a new opening degree of the valve having the operator request reflected therein may be identically performed.

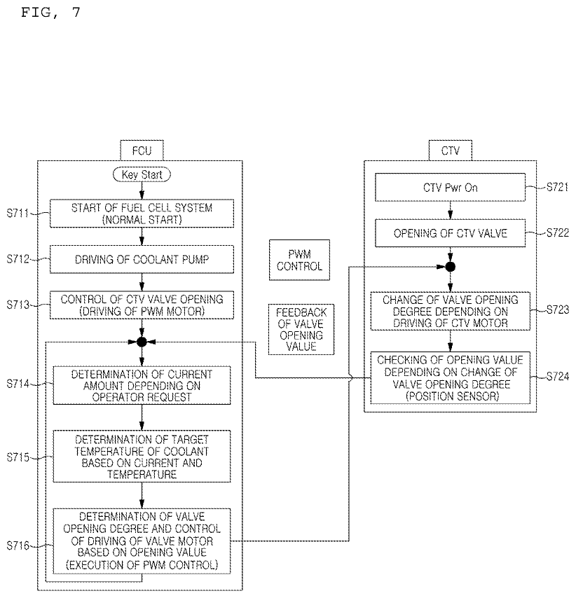

FIG. 7 is a flowchart showing a coolant temperature adjustment valve control method of the fuel cell system in the integrated fuel cell control method according to the present disclosure, wherein the method of FIG. 7 is substantially identical to the method of FIG. 6 except that the thermal management device is a target.

That is, when the fuel cell system is started (S711), the coolant pump is driven (S712), and the fuel cell control unit performs CTB valve opening control based on an initially set opening degree of the valve (S713). The CTB valve opening control in this step (S713) means directly driving the coolant temperature adjustment valve based on a valve control amount set according to the initial opening degree of the valve under PWM control of the motor. Consequently, the driving motor is opened by PWM motor drive control, and the coolant temperature adjustment valve (the CTV valve) is opened (S722).

In an initial state, in which the opening degree of the valve is not changed, step S723 may be omitted, and an opening value of the valve may be checked by a position sensor in step S724. The checked opening value of the valve may be transmitted to the fuel cell control unit as an analog feedback signal of the position sensor so as to be utilized to determine the opening degree of the valve to be newly changed.

In connection therewith, the fuel cell control unit determines a new valve opening degree based on the fed-back opening value of the CTV valve and an operator request value (S714 and S715). General techniques used in a conventional fuel cell system may be applied to a process of determining the new valve opening degree. For example, a required amount of stack current is determined depending on operator request (S714), and a target temperature of the coolant may be determined based on required current and external air temperature according to this value (S715). At this time, the target temperature of the coolant determined in this step is provided to calculate the required opening degree of the coolant temperature adjustment valve. Meanwhile, unlike FIG. 7, the required opening degree of the valve may be directly calculated based on the target temperature of the coolant determined in step S716.

When the opening degree of the valve to be changed is determined through the above process, a step of controlling driving of the motor of the valve based on the determined opening degree of the valve to be changed is performed (S716). In this step (S716), PWM drive control for the motor may be performed in real time based on a command value of the fuel cell control unit to change the opening degree of the valve (S723).

When motor drive control for satisfying a desired opening degree of the valve is completed, a step of checking the current opening degree of the valve again through the position sensor (S724) may be performed, and a process of adjusting the opening of the CTV valve based on a new opening degree of the valve having the operator request reflected therein may be identically performed.

According to the integrated fuel cell control apparatus and method described above, in the devices in the fuel cell system having the DC motor, which functions as an actuator, it is possible to remove a control circuit installed in each device, whereby structural simplification and efficient control are possible.

As is apparent from the above description, an integrated fuel cell control system according to the present disclosure and a control method using the same have an effect in that it is possible to remove a control circuit from a system part including a DC motor in a fuel cell system, whereby it is possible to reduce cost of manufacturing the fuel cell system.

In addition, it is possible to remove some control units of subordinate systems, whereby it is possible to simplify the internal structure of a system part, and part design based on a passive element, such as a motor, and mechanical hardware is possible, whereby it is possible to minimize an electric circuit.

In addition, according to the present disclosure, it is possible to directly control parts of the subordinate systems through the fuel cell control unit, whereby control efficiency is improved, and the fuel cell control unit is capable of directly perform PWM drive and fault diagnosis of each drive motor.

In addition, according to the present disclosure, it is possible to remove CAN communication required between the fuel cell control unit and a subordinate control unit, whereby it is possible to reduce CAN load.

Although the preferred embodiments of the present disclosure have been described above with reference to the accompanying drawings, those skilled in the art will appreciate that the present disclosure can be variously modified and changed without departing from the technical idea of the present disclosure defined by the appended claims.

What is claimed is:

1. An integrated fuel cell control system comprising:
at least one valve installed to control a fluid in a fuel cell system;
at least one drive motor to drive the at least one valve;
at least one sensor to detect an opening degree of the at least one valve; and
a fuel cell control unit configured to control the fuel cell system, wherein
the fuel cell control unit comprises:
a drive logic unit configured to calculate a motor control amount for controlling the at least one drive motor based on information detected by the at least one sensor and an operator request value; and
a drive unit configured to operate the at least one drive motor based on the motor control amount determined by the drive logic unit.

2. The integrated fuel cell control system according to claim 1, wherein the fuel cell control unit further comprises a power unit configured to operate the driving motor in order to open the at least one valve.

3. The integrated fuel cell control system according to claim 1, wherein the at least one valve is an air pressure adjustment valve to control air pressure or a coolant temperature adjustment valve to control coolant temperature.

4. The integrated fuel cell control system according to claim 1, wherein
the at least one valve is an air pressure adjustment valve to control pressure of supplied air,
the sensor checks a current opening degree of the air pressure adjustment valve and transmits the current opening degree of the air pressure adjustment valve to the drive logic unit, and
the drive logic unit determines an opening degree of the air pressure adjustment valve to be changed based on the current opening degree of the air pressure adjustment valve and the operator request value, and calculates the motor control amount based on the opening degree of the air pressure adjustment valve to be changed.

5. The integrated fuel cell control system according to claim 1, wherein
the at least one valve is a coolant temperature adjustment valve to control coolant temperature,
the sensor checks a current opening degree of the coolant temperature adjustment valve and transmits the current opening degree of the coolant temperature adjustment valve to the drive logic unit, and
the drive logic unit determines an opening degree of the coolant temperature adjustment valve to be changed based on the current opening degree of the coolant temperature adjustment valve and the operator request value, and calculates the motor control amount based on the opening degree of the coolant temperature adjustment valve to be changed.

6. The integrated fuel cell control system according to claim 4, wherein
the at least one drive motor is a direct-current motor,
the motor control amount is a PWM control drive current value to be applied to the at least one drive motor in order to control the air pressure adjustment valve based on the opening degree of the air pressure adjustment valve to be changed, and
the drive unit directly applies drive current based on the PWM control drive current value to the at least one drive motor in order to operate the at least one drive motor such that the current opening degree of the air pressure adjustment valve is changed to the opening degree of the air pressure adjustment valve to be changed.

7. An integrated fuel cell control method comprising:
a valve opening control step of controlling, by a fuel cell control unit, opening of a valve according to a predetermined initial condition at a time of start of a fuel cell system;
an opening-degree-of-valve checking step of checking, by a sensor, an opening degree of the valve;
a step of calculating, by the fuel cell control unit, a motor control amount for controlling a drive motor with respect to the valve based on the opening degree of the valve checked in the opening-degree-of-valve checking step and an operator request value; and
a step of operating, by the fuel cell control unit, the drive motor based on the motor control amount.

8. The integrated fuel cell control method according to claim 7, wherein, the opening-degree-of-valve checking step includes directly receiving, by the fuel cell control unit, a signal from the sensor to check the opening degree of the valve.

9. The integrated fuel cell control method according to claim 7, wherein
the valve is an air pressure adjustment valve configured to control pressure of supplied air,
the opening-degree-of-valve checking step includes checking, by the sensor, a current opening degree of the air pressure adjustment valve, and
the step of calculating the motor control amount includes determining, by a drive logic unit of the fuel cell control unit, an opening degree of the air pressure adjustment valve to be changed based on the current opening degree of the air pressure adjustment valve and the operator request value, and calculating, by the drive logic unit, the motor control amount based on the opening degree of the air pressure adjustment valve to be changed.

10. The integrated fuel cell control method according to claim 7, wherein
the valve is a coolant temperature adjustment valve configured to control coolant temperature,
the opening-degree-of-valve checking step includes checking, by the sensor, a current opening degree of the coolant temperature adjustment valve, and
the step of calculating the motor control amount includes determining, by a drive logic unit of the fuel cell control unit, an opening degree of the coolant temperature adjustment valve to be changed based on the current opening degree of the coolant temperature adjustment valve and the operator request value, and calculating, by the drive logic unit, the motor control amount based on the opening degree of the coolant temperature adjustment valve to be changed.

11. The integrated fuel cell control method according to claim 9, wherein
the drive motor is a direct-current motor,
the motor control amount is a PWM control drive current value to be applied to the drive motor in order to control the air pressure adjustment valve based on the opening degree of the air pressure adjustment valve to be changed, and
the step of operating the drive motor includes generating, by a drive unit of the fuel cell control unit, the PWM control drive current and directly applying the PWM control drive current to the drive motor in order to operate the drive motor such that the current opening degree of the air pressure adjustment valve is changed to the opening degree of the air pressure adjustment valve to be changed.

12. The integrated fuel cell control system according to claim 5, wherein
the at least one drive motor is a direct-current motor,
the motor control amount is a PWM control drive current value to be applied to the at least one drive motor in order to control the coolant temperature adjustment valve based on the opening degree of the coolant temperature adjustment valve to be changed, and
the drive unit directly applies drive current based on the PWM control drive current value to the at least one drive motor in order to operate the at least one drive motor such that the current opening degree of the coolant temperature adjustment valve is changed to the opening degree of the coolant temperature adjustment valve to be changed.

13. The integrated fuel cell control method according to claim 10, wherein
the drive motor is a direct-current motor,
the motor control amount is a PWM control drive current value to be applied to the drive motor in order to control the coolant temperature adjustment valve based on the opening degree of the coolant temperature adjustment valve to be changed, and
the step of operating the drive motor includes generating, by a drive unit of the fuel cell control unit, the PWM control drive current and directly applying the PWM control drive current to the drive motor in order to operate the drive motor such that the current opening degree of the coolant temperature adjustment valve is changed to the opening degree of the coolant temperature adjustment valve to be changed.
